(19) United States
(12) Patent Application Publication
(10) Pub. No.: US 2024/0278670 A1
(43) Pub. Date: Aug. 22, 2024

(54) ELECTRIC VEHICLE SERVICE STATION

(71) Applicant: WORKSPORT LTD., Mississauga (CA)

(72) Inventors: Lorenzo ROSSI, Mississauga (CA); Steven ROSSI, Mississauga (CA)

(21) Appl. No.: 18/569,533

(22) PCT Filed: Jun. 14, 2022
(86) PCT No.: PCT/IB2022/000327

§ 371 Date: Dec. 12, 2023

Related U.S. Application Data
(60) Provisional application No. 63/210,288, filed on Jun. 14, 2021.

(51) Int. Cl. B60L 53/54; B60L 53/14; B60L 58/30

(52) U.S. Cl. CPC B60L 53/54; B60L 53/14; B60L 58/30

(57) ABSTRACT

An EV service station is provided. The EV service station includes a hydrogen storage tank configured to supply hydrogen to a hydrogen fuel cell unit. The hydrogen fuel cell unit converts hydrogen into electrical power so as to charge a battery bank. A power control unit draws power from the battery bank to a power outlet configured to couple with an EV so as to charge the EV. As hydrogen is provided for charging operations, the EV service station is not reliant upon electricity from a utility provider such as a commercial power grid.

### CROSS-REFERENCE TO RELATED APPLICATION

This application claims the benefit of U.S. Provisional Patent Application No. 63/210,288 filed Jun. 14, 2021, the contents of which are incorporated herein.

### TECHNICAL FIELD

This disclosure relates to electric vehicle service equipment, and more particularly to a service station providing electricity to an electric vehicle for recharging of the electric vehicle's batteries.

### BACKGROUND

While owning an electric vehicle (EV), such as an electric automobile, has many benefits (such as reduced environmental impact, utilization of a renewable energy source, less maintenance and less noise than an internal combustion (IC)), an EV also has some drawbacks in comparison to an IC vehicle. Examples of such drawback include being a longer refueling (recharging) times, shorter mileage range and a lack of EV charging or service stations throughout the vast network of roads and highways. For EVs to fully compete with IC vehicles, the above drawbacks need to be overcome.

EV service stations, sometimes referred to as charging stations, have been and continue to be deployed in many communities. Typically, EV service stations are deployed in urban and suburban communities where drivers of EVs are most often found, in part because of the shorter driving range of the EV. EV service stations are often located in public parking garages/lots, in the parking lots of retail business and/or in the parking lots adjacent to where the EV driver may be employed or accesses public transportation.

One requirement for the location of an EV service station is a connection to the local electric power grid. This requirement restricts the number of suitable locations. Furthermore, if installed and later removed, various artifacts from the EV service station remain, including the cabling used in connecting the EV service station to the power grid. The lack of access to the electric power grid, as well as the cost and inconvenience of connecting to the electric power grid has limited a greater deployment of EV service stations, particularly along stretches of rural roads and highways and limited access roads and highways.

### SUMMARY

A service station for charging an EV includes a hydrogen storage tank, a hydrogen fuel cell unit, a battery bank, and a system controller. The hydrogen storage tank is configured to contain hydrogen. The hydrogen storage tank may be configured to be replaced and/or refilled. The hydrogen fuel cell unit is coupled to the hydrogen storage tank and is configured to convert the hydrogen into electrical power. The battery bank has a predetermined capacitance and is electrically coupled to the hydrogen fuel cell unit so as to be charged by the hydrogen fuel cell unit. The system controller is configured to direct a charging of the EV from the battery bank, and to maintain the predetermined capacitance of the battery bank.

The service station may include one or more of the following aspect, which may be independent of each other or combined with each other. In one aspect, the service station further includes a power control unit configured to process the power from the battery bank to charge the EV.

In another aspect, the system controller is further configured to transmit a signal to a service provider to replenish the hydrogen storage tank when the hydrogen storage tank is below a predetermined threshold.

In another aspect, the service station further includes a pressure regulator to regulate pressure at which hydrogen is supplied to the hydrogen fuel cell unit. In another aspect, the service station further includes a purge valve coupled to the hydrogen storage tank. The purge valve is configured to purge non-hydrogen gases so as to prevent non-hydrogen gases from entering the hydrogen fuel cell unit.

In another aspect, the system controller is configured to monitor a failure of a hydrogen fuel cell in the hydrogen fuel cell unit and direct a functioning hydrogen fuel cell in the hydrogen fuel cell unit to charge the battery bank.

In another aspect, the system controller is configured to switch a charging operation of the EV from the battery bank to the hydrogen fuel cell so as to have the hydrogen fuel cell unit charge the EV directly.

In another aspect, the system controller is configured to actuate the power control unit so as to blend an output from the hydrogen fuel cell unit and the battery bank to form a power output for charging the EV.

In yet another aspect, the service station further includes an energy recovery system configured to convert heat generated by the hydrogen fuel cell unit into electricity, the electricity charging the battery bank. The energy recovery system may include a tile disposed within a radiator.

The disclosure also relates to a non-parasitic service station for charging an EV. The non-parasitic service station includes a hydrogen storage tank, a hydrogen fuel cell, a battery bank, a power control unit and a power outlet. The hydrogen fuel cell is fluidly coupled to the hydrogen storage tank and is configured to process the hydrogen into an electrical output. The battery bank includes a plurality of batteries. The power control unit is connected to the electrical output of the hydrogen fuel cell and couples the electrical output of the hydrogen fuel cell to the battery bank. The power control unit is configured to provide a charging current to the battery bank for charging and maintaining of the batteries. The power outlet is configured to electrically couple with the EV so as to charge the EV with the charging current.

The non-parasitic service station may include one or more of the following aspect, which may be independent of each other or combined with each other. In one aspect, the one or more of the hydrogen storage tank, hydrogen fuel cell, battery bank, power control unit and the power outlet are provided on one or more intermodal containers.

In one aspect, the fuel cell is one of a plurality of fuel cells. In another aspect, the non-parasitic service station incorporates double redundancy in its modes of operation.

In yet another aspect, the station incorporates an energy recovery system associated with the fuel cells. In such an aspect, the energy recovery system includes a thermoelectric generator.

In one aspect, the hydrogen tank is refillable and/or replaceable.

In one aspect, non-parasitic service station is operable to charge EVs using only the hydrogen fuel cell.

In one aspect, the non-parasitic service station is operable to charge EVs using only the batteries.

In one aspect, the non-parasitic service station is operable to charge EVs using the fuel cells and batteries simultaneously.

In one aspect, the controller is configured to wirelessly transmit service requests based on one or more monitored parameters of the station.

### Advantageous Effects

The present disclosure overcomes the disadvantages and limitations of current EV service stations by eliminating the need to couple with a commercial power grid. Thus, in less developed areas, or areas where access to a power grid is not available, the non-parasitic service station is able to charge EVs.

### BRIEF DESCRIPTION OF THE DRAWINGS

FIG. 1 is a block diagram of an EV service station incorporating the principles of the present invention.

FIG. 2 is a schematic diagram of part of an energy recovery system employed with the EV service station seen in FIG. 1.

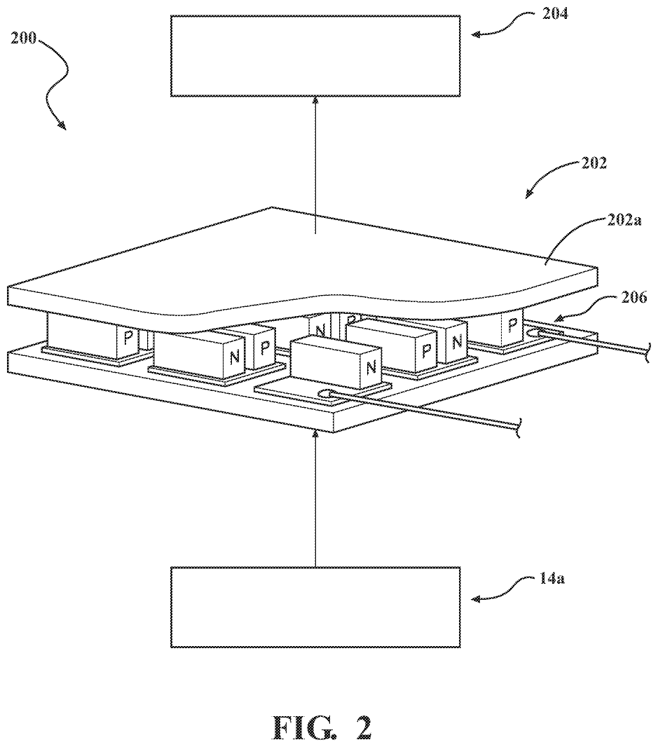

### DETAILED DESCRIPTION OF PREFERRED EMBODIMENTS

An EV service station is provided. The EV service station includes a hydrogen storage tank configured to supply hydrogen to a hydrogen fuel cell unit. The hydrogen fuel cell unit converts hydrogen into electrical power so as to charge a battery bank. A power control unit draws power from the battery bank to a power outlet configured to couple with an EV so as to charge the EV. As hydrogen is provided for charging operations, the EV service station is not reliant upon electricity from a utility provider such as a commercial power grid.

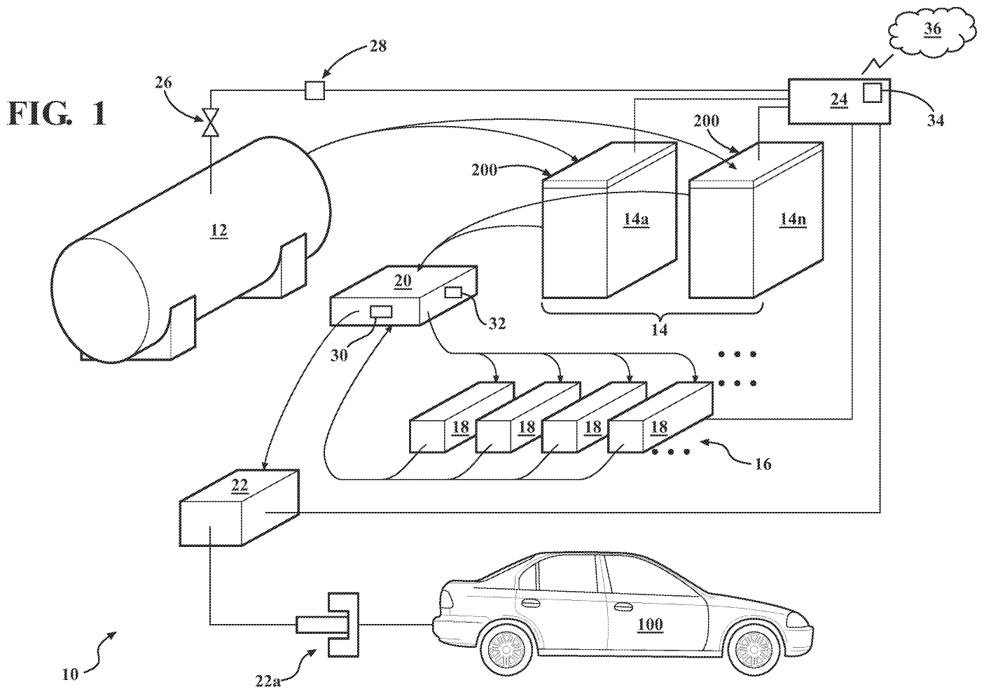

Referring now to the diagram seen in FIG. 1, depicted therein is an EV service station 10 embodying the principles of the present disclosure. The EV service station 10 is non-parasitic, meaning the EV service station 10 requires no electrical load from a local electrical power grid. Accordingly, the EV service station 10 may be referred to as an off-grid service station for any vehicle that is powered by electricity, either fully or partially, such as a plug-in hybrid EV, collectively referenced herein as EVs (100).

The EV station 10 includes as its primary components a hydrogen storage tank 12, a hydrogen fuel cell unit 14 (preferably the hydrogen fuel cell unit 14 has at least two hydrogen fuel cells 14a), a battery bank 16 including a plurality of individual batteries 18, a power control unit 20, a power outlet 22 and a system controller 24.

### The Hydrogen Storage Tank

For illustrative purposes, the EV station 10 is shown as having a single hydrogen storage tank 12. The hydrogen storage tank 12 is dimensioned to provide a predetermined amount of hydrogen to the hydrogen fuel cell unit 14. Thus, the size and number of hydrogen storage tanks 12 is not limiting to the scope of the appended claims but may be dimensioned based upon a projected use or need for hydrogen. For illustrative purposes, the hydrogen storage tank 12 is a cylindrical member configured to store 850 Liters of hydrogen. The hydrogen storage tank 12 may be filled with liquid hydrogen supplied from a corresponding liquid hydrogen tanker truck (not shown), or supplied by other means, such as replaceable/refillable hydrogen tanks, a hydrogen pipeline or hydrogen generator. The form for the supplying of the hydrogen will depend on numerous factors, including the amount of needed hydrogen, the geographic location, accessibility and space availability. For example, the system may employ a stationary, large on-site refillable hydrogen storage tanks 12. Alternatively, the system may employ a plurality of replaceable upright hydrogen storage tanks 12 that are swapped out when one or more of the tanks are empty or low.

Associated with the hydrogen storage tank 12, in addition to a pressure regulator(s) 26 to regulate the pressure at which hydrogen is supplied to the hydrogen fuel cell unit 14, is also a purge valve 28 for purging non-hydrogen gases that have entered the EV service system 10. The purge valve 28 is particularly important whenever the EV service system 10 employs replaceable hydrogen storage tanks 12. When swapping the hydrogen storage tanks 12, small amounts non-hydrogen gases may enter the EV service system 10. This is a problem for hydrogen fuel cells 14a since hydrogen fuel cells 14a require 99% pure hydrogen gas to ensure that damage does not result. The purge valve 28 is configured to remove non-hydrogen gases (such as air), thus ensuring that only pure hydrogen gas enters the hydrogen fuel cells 14a.

### The Hydrogen Fuel Cell Unit

While the specific construction of the hydrogen fuel cell unit 14 is beyond the scope of the present disclosure and may and will actually vary depending the design criteria and capacity of the particular EV service station 10, very generally a hydrogen fuel cell unit 14 includes pairs of anode and cathode plates separated by a polymer electrolyte membrane. A flow plate channels the hydrogen gas, provided at the regulated pressure, from the hydrogen storage tank 12 to the anode, which includes a catalyst, usually platinum or carbon. At the anode, oxidation of the hydrogen occurs and negative hydrogen electrons are separated from positive hydrogen protons. The polymer electrolyte membrane passes/conducts the positively charged protons from the anode, through the polymer electrolyte membrane and to the cathode. The negatively charged electrons, however, are not passed/conducted through the polymer electrolyte membrane. Rather, the negatively charged electrons must flow along an electrical conductor/circuit, from the flow plate associated with the anode, to the flow plate associated with the cathode, thus establishing an electrical current. At the cathode, which similarly employs a catalyst material such as platinum or carbon, oxygen directed by the flow plate combines with the hydrogen electrons and protons to form water and heat, which are channeled away from the flow plate as the byproducts of the chemical reaction creating the electrical current. Electricity generated by the hydrogen fuel cell unit 14 is transmitted to

### The Power Control Unit

The power control unit 20 is configured balance power between the hydrogen fuel cell unit 14 and the battery bank 14 so as to maintain an optimum charge function for charging the battery bank 14. The power control unit 20 may be further configured to blend power from the hydrogen fuel cell unit 14 and the battery bank 16 to provide a predetermined power output (e.g. voltage and current) to the power outlet 22 to charge the EV 100. The power control unit 20 includes electronic components, such as relays, fuses and capacitors for charging the battery bank 16 in a manner which optimizes the charging of the battery bank 16.

The power control unit 20 may include a DC/DC converter/rectifier 30. The DC/DC converter/rectifier 30 receives direct current from the hydrogen fuel cell unit 14 and converts the received current, which may vary, into a smooth, regulated current. The smooth, regulated current is then provided to the battery bank 16, enabling each battery 18 in the battery bank 16 to be charged as a result of the production of electricity by the hydrogen fuel cell unit 14.

### The Battery Bank

As mentioned above, the battery bank 16 includes a plurality of batteries 18. The capacity of the batteries 18 are configured to provide a predetermined amount of power for charging the EV 100. The batteries 18 may be a liquid or solid state battery made of elements which are commonly known or later developed. The capacitance of the battery bank 16 may be determined based upon an intended use. For instance, the battery bank 16 may have a greater capacitance in an area that is more populated with EVs 100 than a battery bank 16 used in an area that is populated with less EVs 100. The batteries 18 of the battery bank 16 may be connected to one another in series or parallel in order to provide the desired output voltage to the DC/DC converter/rectifier 30, which in turn provides the power to the power outlet 22. The batteries 18 are also connected to the DC/DC converter/rectifier 30 so as to be drawn upon and provide a voltage output for charging the batteries 18 of the EV 100.

### The Power Outlet

The power outlet 22 is configured to receive regulated power from the power control unit 20. The power outlet 22 is also connected to the EV 100 via a receptacle and plug connection collectively referenced as 22a. The plug may be disposed on one of either the power outlet 22 or the EV 100. Any receptacle and plug connection currently known or later developed may be modified for use herein. The power outlet 22 may include switches and fuses to prevent an inrush of current from the EV 100 to the EV service station 10. For illustrative purposes, the power outlet 22 and the power control unit 20 are shown disposed in separate housings; however, it should be appreciated that the power outlet 22 and the power control unit 20 may be housed together in a single housing.

The system controller 24 may monitor the charge status of the individual batteries 18 of the battery bank 16, or the collective charge status of the battery bank 16 and switch the batteries 18 being drawn upon, or otherwise charged by the hydrogen fuel cell unit 14, based upon the individual and collective state of charge of the batteries 18 and the battery bank 16 as the case may be. Similarly, the power control unit 20 monitors the state of charge of the batteries 18 and controls operation of the hydrogen fuel cell unit 14 to provide charging current, via the DC/DC converter/rectifier 30, to the batteries 18 to charge and maintain the batteries 18. It should be appreciated that the power control unit 20 and/or the system controller 24 may receive the capacitance of the hydrogen fuel cell unit 14 and the battery bank 16 using a first sensor unit 32 configured to detect the amount of current output from the respective hydrogen fuel cell unit 14 and the battery bank 16 and the voltage of the hydrogen fuel cell unit 14 and the battery bank 16. The first sensor unit 32 may include any sensor currently known and used or later developed which may be modified for use herein illustratively including a transducer, a shunt resistor, voltage dividers or the like.

The system controller 24 also monitors the hydrogen tank for the level of liquid hydrogen therein and the supply of hydrogen to the hydrogen fuel cell unit 14 during charging of the batteries 18. If the amount of hydrogen in the hydrogen storage tank 12 drops below a predetermined threshold, the system controller 24 is configured to initiate a service request (for refilling and or replacement), which may be submitted via a wireless signal, such as cellular or WiFi, directly to the appropriate service provider. The predetermined threshold may be based upon one or a combination of factors, to include pressure or weight. In response to reaching the predetermined threshold in the hydrogen storage tank 12, the system controller 24 adjusts the functionality of the hydrogen fuel cell to the lower pressure input. Regarding the hydrogen fuel cell unit 14, the controller further monitors the hydrogen fuel cells 14a with regard to temperature and other parameters, and controls the operation thereof accordingly.

The system controller 24 also monitors the EV service station 10 for power output failure and provides a double redundancy that is built into the EV service station 10. The system controller 24 may include a computer program having an executable program written on a non-volatile memory which is configured to execute functions for controlling various aspects of the EC service station 10 as described in more detail below.

In one aspect, the hydrogen fuel cell unit 14 includes two hydrogen fuel cells 14a and a rapid charge battery bank 16. The two fuel cells work in unison to deliver the “load” to battery bank 16 as the EV 100 is being charged so as to replenish the battery bank 16 as power is being drawn from a charging operation. If one of the hydrogen fuel cells 14a happens to fail, the system controller 24 makes a switch and actuates the other hydrogen fuel cell 14a to take over and continue charging the battery bank 16. A failure may be determined in instances where hydrogen is stored in the hydrogen fuel cell 14a and little or no power is being discharged. In such an instance, the first sensor unit 32 may detect no current or a low voltage in the hydrogen fuel cell 14a and detects that hydrogen is supplied to the hydrogen fuel cell 14a by receiving a pressure information from the pressure regulator 26.

This is a first stage of redundancy. In this instance, the system controller 24 also sends a wireless service request for maintenance which may be transmitted via an antenna 34 to a remote server 36. If both hydrogen fuel cells 14a fail, the system controller 24 continues charging the EV 100 via the battery bank 16. With the failure of both fuel cells 14a, the system controller 24 also sends a wireless request for service with regard to the failed hydrogen fuel cells 14a. This second redundancy stage also kicks-in also if the hydrogen tank(s) 12 is completely depleted and the hydrogen fuel cells 14a are no longer active due to lack of hydrogen and not a failure of the hydrogen fuel cells 14a.

The system controller 24 is also responsible for keeping the hydrogen fuel cell 14a continuously “awake.” This is achieved by maintaining a minimum level of activity and by not turning the hydrogen fuel cell 14a completely off or shutting it fully down. This minimal level of activity, a “hibernation state” of activity, is employed whenever the hydrogen fuel cell 14a is not being utilized to charge the battery bank 16, or otherwise provide a load. It has been discovered that by implementing a hibernation state of activity, the lifetime and durability of the hydrogen fuel cell 14a can be extended. The hydrogen fuel cell 14a reach very high operating temperatures and the hard cold/hot cycle (shut down=cold) is believed to be very detrimental to the hydrogen fuel cell 14a, thus, keeping the hydrogen fuel cell 14a “warm” in the hibernation state dramatically improves the mean time between failures. In instances where the hydrogen fuel cell unit 14 and the battery bank 16 are fully charged and the temperature is below 0 degrees Celsius, the system controller 24 is configured to discharge the battery bank 16 or the hydrogen fuel cell unit 14 so as to maintain the minimal level of activity and warm up the hydrogen fuel cell unit 14.

Power for operation of the system controller 24 is in turn drawn from the batteries 18 through the power control unit 20. As such, the EV service station 10 disclosed herein is non-parasitic and may be provided as an off-grid service station for EVs 100.

In another aspect, the power control unit 20 is configured to process the electrical power from the hydrogen fuel cell unit 14 so as to charge the EV 100 directly. Such an aspect may be useful in instances where the capacitance of the battery bank 16 is not sufficient to perform a charging operation of the EV 100. In another aspect, the system controller 24 may be further configured to actuate the power control unit 20 so as to charge the EV using both the hydrogen fuel cell unit 14 and the battery bank 16. In such an aspect, the power control unit 20 blends the output from the hydrogen fuel cell unit 14 and the battery bank 16 to form a power output which is suitable for charging the EV 100.

The EV service station 10 may also employ an energy recovery system 200. One such system 200 utilizes solid state thermoelectric generators (TEG) 202 to covert heat flux directly into additional electrical energy. While active, hydrogen fuel cells 14a generate heat and can reach a temperature of up to 80° Celsius. This heat is typically dissipated via radiators 204, which are commensurate to the fuel cell power and design. Typically these radiators are very similar to the ones used in cars and contain an ethylene glycol cooling fluid. With the present system 200, the hydrogen fuel cells 14a incorporate with the radiators 202 an intermediate stage including a thermoelectric generator 202 formed as a tile 202a having of a layer of Seebeck/Peltier TEG 206, each of which is capable of generating an estimated average of 4 to 6 volts per tile via heat recovery (based on an 80° Celsius operating temp of the fuel cell). The tiles 202a will generate power commensurate to its surface area. Therefore, an area of ten (10) tiles 202a, approximately 1600 mm2 (the tiles have a standardized 40 mm×40 mm size) will generate an additional estimated 40 to 60 volts of electrical power, with the opportunity of increasing the power capacity of the EV service station 10 depending on how many tiles 202a of TEGs are used in the EV service station 10.

As described, the EV service station 10 may be provided as an on-site constructed station and scaled as desired. Alternatively, the various components of the EV service station 10 may be housed in one or more intermodal containers for ease of transport, distribution, locating, installation and relocation of the EV service station 10. Deployment at the installation site thereafter requires, after development of the site, only appropriate interconnecting of the components and installation of appropriate charging kiosks having EV charging connectors for connecting the EV to the EV service station 10 and point of sale payment options for use thereof.

Should it later be determined that the EV community would be better served with the EV service station 10 in a different location, the EV service station 10 can readily be moved and relocated with requiring significant restoration of the site and without leaving behind obsolete infrastructure components.

As a person skilled in the art will readily appreciate, the above description is only meant as an illustration of an implementation of the principles of the present invention. Accordingly, this description is not intended to limit the scope or application of this invention since the invention is susceptible to modification, variation and change, all without departing from the spirit of the invention, as defined in the following claims.

1. A service station for charging an EV, the service station comprising:
a hydrogen storage tank containing hydrogen;
a hydrogen fuel cell unit coupled to the hydrogen storage tank and configured to convert hydrogen into electrical power;
a battery bank having a predetermined capacitance, the battery bank electrically coupled to the hydrogen fuel cell unit so as to be charged by the hydrogen fuel cell unit; and
a system controller configured to direct a charging of the EV from the battery bank, and to maintain the predetermined capacitance of the battery bank.

2. The service station as set forth in claim 1, further including a power control unit configured to process the power from the battery bank to charge the EV.

3. The service station as set forth in claim 1, wherein the system controller is further configured to transmit a signal to a service provider to replenish the hydrogen storage tank when the hydrogen storage tank is below a predetermined threshold.

4. The service station as set forth in claim 1, further including a pressure regulator to regulate pressure at which hydrogen is supplied to the hydrogen fuel cell unit.

5. The service station as set forth in claim 1, further including a purge valve coupled to the hydrogen storage tank, the purge valve configured to purge non-hydrogen gases so as to prevent non-hydrogen gases from entering the hydrogen fuel cell unit.

6. The service station as set forth in claim 1, wherein the system controller is configured to monitor a failure of a hydrogen fuel cell in the hydrogen fuel cell unit and direct a functioning hydrogen fuel cell in the hydrogen fuel cell unit to charge the battery bank.

7. The service station as set forth in claim 1, wherein the system controller is configured to switch a charging operation of the EV from the battery bank to the hydrogen fuel cell so as to have the hydrogen fuel cell unit charge the EV directly.

8. The service station as set forth in claim 1, wherein the system controller is configured to actuate the power control unit so as to blend an output from the hydrogen fuel cell unit and the battery bank to form a power output for charging the EV.

9. The service station as set forth in claim 1, further including an energy recovery system configured to convert heat generated by the hydrogen fuel cell unit into electricity, the electricity charging the battery bank.

10. The service station as set forth in claim 9, wherein the energy recovery system includes a tile disposed within a radiator.

11. A non-parasitic service station for charging an EV, the non-parasitic service station comprising:
a hydrogen storage tank,
a hydrogen fuel cell, the hydrogen fuel cell being fluidly coupled to the hydrogen storage tank and having an electrical output;
a battery bank including a plurality of batteries;
a power control unit connected to the electrical output of the hydrogen fuel cell and coupling electrical output of the hydrogen fuel cell to the battery bank, the power control unit configured to provide a charging current to the battery bank for charging and maintaining of the batteries; and
a power outlet configured to electrically couple with the EV so as to charge the EV with the charging current.

12. The non-parasitic service station as set forth in claim 11, wherein one or more of the hydrogen storage tank, hydrogen fuel cell, battery bank, power control unit and the power outlet are provided on one or more intermodal containers.

13. The non-parasitic service station according to claim 11, wherein the fuel cell is one of a plurality of fuel cells.

14. The non-parasitic service station according to claim 11, wherein the non-parasitic service station incorporates double redundancy in its modes of operation.

15. The non-parasitic service station according to claim 11, wherein the non-parasitic service station incorporates an energy recovery system associated with the fuel cells.

16. The non-parasitic service station according to claim 6, wherein the energy recovery system includes a thermoelectric generator.

17. The non-parasitic service station according to claim 11, wherein the hydrogen tank is refillable.

18. The non-parasitic service station according to claim 11, wherein the hydrogen tank is replaceable.

19. The non-parasitic service station according to claim 11, wherein the non-parasitic service station is operable to charge EVs using only the fuel cells.

20. The non-parasitic service station according to claim 11, wherein the non-parasitic service station is operable to charge EVs using only the batteries.

21. The non-parasitic service station according to claim 11, wherein the non-parasitic service station is operable to charge EVs using the fuel cells and batteries simultaneously.

22. The non-parasitic service station according to claim 11, wherein the controller is configured to wirelessly transmit service requests based on one or more monitored parameters of the station.
